(19) United States
(12) Patent Application Publication
(10) Pub. No.: US 2025/0161827 A1
(43) Pub. Date: May 22, 2025

(54) Task Processing Method and System, Device, Medium, and Program Product

(71) Applicant: Shanghai Lilith Technology Corporation, Shanghai (CN)

(72) Inventors: Hao Meng, Shanghai (CN); Lingxi Ji, Shanghai (CN); Jingkai Liu, Shanghai (CN); Xiaofeng Chen, Shanghai (CN)

(21) Appl. No.: 18/560,826

(22) PCT Filed: Nov. 29, 2022
(86) PCT No.: PCT/CN2022/134920

§ 371 Date: Feb. 3, 2025

(51) Int. Cl. A63F 13/86; A63F 13/69; A63F 13/79

(52) U.S. Cl. CPC A63F 13/86; A63F 13/69; A63F 13/79

(57) ABSTRACT

The present invention relates to a task processing method for a game session. The method includes: receiving a game spectating request from a first game terminal, obtaining a game screen of a spectated character corresponding to the game spectating request, and sending the game screen to the first game terminal; receiving request information from the first game terminal, where the request information includes at least one predetermined task; sending the predetermined task to at least one game terminal in the game session; in response to a determination operation received by any game terminal for the predetermined task, determining that a game character who meets a predetermined condition is an executor of the predetermined task; and based on an execution result of the predetermined task, allocating a game resource reward to a game account corresponding to the executor.

### TECHNICAL FIELD

The present invention relates to the field of computer data processing, in particular to a task processing method and system for a game session, a device, a medium, and a program product.

### BACKGROUND

In a game scenario in which multiple players participate jointly, especially in a shooting game scenario, a game process can be divided into multiple independent game sessions, each game session can allow players from at least two camps to participate, and after combating, a camp that has at least a game character still alive at the end wins. In a game session, if a game character controlled by a player fails to perform a task, or is killed by another game character, the current game session is terminated for the player, the player can watch a game character controlled by a player for which the game is not terminated in the current game session, that is, the game character for which the game is terminated is used as a spectating character, and a game interface of a game character who is playing the current game (that is, a spectated character) is displayed on a game terminal corresponding to the spectating character, so that the player corresponding to the spectating character can observe the game process of the spectated character. In the prior art, the interaction between the spectating character and the spectated character is limited. For example, the spectating character taps the like icon for the spectated character. This interaction manner has too little interactive content, and it is difficult to give the player corresponding to the spectating character an immersive experience of participating in the game. Consequently, neither the player corresponding to the spectating character nor the player corresponding to the spectated character can experience the immersive interactive fun like a live broadcast.

In addition, in the game session, a system sets some tasks for the game character. These tasks are released by the system, and the mode and content of the tasks are relatively simple. For example, the game characters are required to reach a specified place within a specified time period.

The current setting of many game tasks can no longer provide the game player with an excellent game experience. In order to pursue higher game interaction quality, the present invention provides a task processing method for a game session, the fun of interaction between the player corresponding to the spectating character and the player corresponding to the spectated character is increased in a manner in which task release links and task upgrade links are independently set by the players and corresponding game resource rewards are provided.

### SUMMARY

An objective of the present invention is to provide a task processing method and system for a game session, a device, a medium, and a program product. The present invention closely connects a spectating character and a spectated character in a game by adding tasks release and task update links, so that interactive fun between a player corresponding to the spectating character and a player corresponding to the spectated character can be significantly improved.

An embodiment of the present invention discloses a task processing method for a game session, and the method includes:
an obtaining step, receiving a game spectating request from a first game terminal, obtaining a game screen of a spectated character corresponding to the game spectating request, and sending the game screen to the first game terminal;
a receiving step, receiving request information from the first game terminal, where the request information includes at least one predetermined task;
a sending step, sending the predetermined task to at least one game terminal in the game session;
a determination step, in response to a determination operation received by any game terminal for the predetermined task, determining that a game character meeting a predetermined condition is an executor of the predetermined task; and
a settlement step, allocating a game resource reward to a game account corresponding to the executor based on an execution result of the predetermined task.

Optionally, the task processing method includes: an updating step, receiving update information from the first game terminal or a second game terminal, where the update information is used to update the predetermined task; where the sending step includes sending the updated predetermined task to at least one game terminal in the game session.

Optionally, the update information includes: any one or a combination of two or more among a difficulty level of the predetermined task, a quantity requirement for kills, limited completion time, and the game resource reward.

Optionally, the receiving step further includes: deducting the game resource reward from a game account corresponding to the first game terminal and temporarily storing the game resource reward; and the settlement step includes, based on the execution result of the predetermined task, adding the game resource reward into a game account corresponding to the executor.

Optionally, the game resource reward is generated and settled by a game system.

Optionally, the request information includes information that is about the predetermined task and the game resource reward, both the predetermined task and the game resource reward are customized by the first game terminal.

Optionally, the receiving step further includes: receiving a refresh information request from any game terminal, where the refresh information request is used to refresh a list of predetermined tasks displayed on a game interface of any game terminal.

Optionally, the settlement step includes: determining a degree of contribution of the executor to completion of the predetermined task, and distributing the game resource reward based on the degree of contribution.

Optionally, in the determination step, within a predetermined time after determining that a game character meeting the predetermined condition is an executor of the predetermined task, a state of the executor is set to be a damage immunity state or a damage reduction state.

Optionally, the sending step includes: sending, to the at least one game terminal, at least one among first display information, second display information, and third display information, where the second display information is sent at predetermined time intervals; the first display information includes at least one among a task list, a task progress, an operation button, and a state prompt; and

the second display information includes at least one among the game resource reward, the predetermined task, and a list of spectating users; and the third display information includes at least one among adding a friend, replaying a video, and switching the spectated character.

An implementation of the present invention discloses an electronic device. The device includes a processor and a memory storing a computer-executable instruction, and the processor is configured to execute the instruction to implement the task processing method.

An implementation of the present invention discloses a non-transitory computer-readable storage medium. At least one computer instruction is stored in the non-transitory computer-readable storage medium, and the at least one instruction is loaded and executed by a processor, to implement the task processing method.

An implementation of the present invention discloses a computer program product.

The computer program product includes a computer instruction, and when the computer instruction is executed, the task processing method is implemented.

An implementation of the present invention discloses a task processing system for a game session, where:
the server receives a game spectating request from a first game terminal, obtains a game screen of a spectated character corresponding to the game spectating request, and sends the game screen to the first game terminal;
the server receives request information from the first game terminal, where the request information includes at least one predetermined task; and the server sends the predetermined task to at least one game terminal in the game session;
in response to a determination operation received by any game terminal for the predetermined task, the server determines that a game character who meets a predetermined condition is an executor of the predetermined task; and
the server allocates a game resource reward to a game account corresponding to the executor based on an execution result of the predetermined task.

The present invention provides a task processing method and system for a game session, a device, a medium, and a program product, and content richness and interest of a game session are increased by allowing players to independently release tasks and update tasks.

The implementations of the present invention are compared with the prior art, and main differences and effects are as follows: The spectating character can release and update the predetermined tasks in a game session, and the spectated character or other game characters can obtain rewards by completing the predetermined tasks, so that a good interaction between a player corresponding to the spectating character and a player corresponding to the spectated character is implemented, and an immersive game experience is provided for the player corresponding to the spectating character and the player corresponding to the spectated character. The configuration of the game link is more user-friendly, and there is no exclusion phenomenon in which a gamer who has been out of the game cannot obtain an interactive game experience in the spectated game.

### BRIEF DESCRIPTION OF DRAWINGS

FIG. 1 is a schematic diagram of a scenario in which a task processing method for a game session is applied according to an embodiment of the present invention;

FIG. 2 is a structural block diagram of a task processing system for a game session according to an embodiment of the present invention;

FIG. 3 is a flowchart of a task processing method for a game session according to an embodiment of the present invention; and

FIG. 4 is a structural block diagram of hardware of an electronic device according to an embodiment of the present invention.

### DETAILED DESCRIPTION OF EMBODIMENTS

The present invention is further described below with reference to specific embodiments and accompanying drawings. It should be understood that the specific embodiments described herein are used merely to explain the present invention, but are not intended to limit the present invention. In addition, for ease of description, only some but not all structures or processes related to the present invention are shown in the drawings. It should be noted that in this description, similar numerals and letters designate like items in the following drawings.

It should be understood that although the terms first, second, etc. may be used in the present disclosure to describe various features, these features should not be limited to these terms. These terms are used for distinction only and shall not be understood as an indication or implication of relative importance. For example, without departing from the scope of example embodiments, a first feature may be referred to as a second feature, and similarly a second feature may be referred to as a first feature.

To make the objectives, technical solutions, and advantages of the present invention clearer, the following further describes the embodiments of the present invention in detail with reference to the accompanying drawings

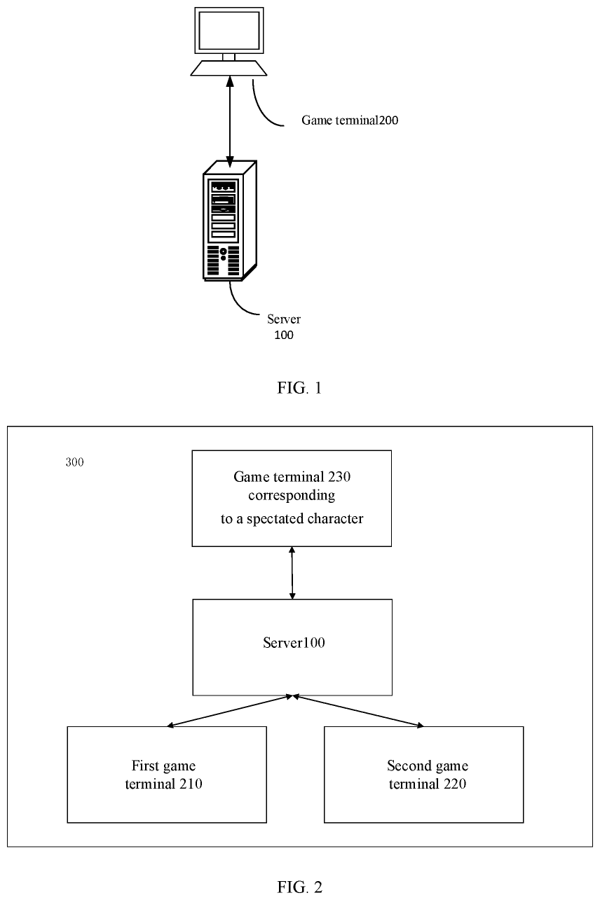

FIG. 1 is a schematic diagram of a scenario in which a task processing method for a game session is applied according to an embodiment of the present invention.

As shown in FIG. 1, an application scenario of the present application includes a server 100 and a game terminal 200, and communication between the server 100 and the game terminal 200 is implemented through connection of a wired network or a wireless network.

It should be noted that the person skilled in the art can understand that there may be one or more game terminals 200, and a quantity of game terminals 200 should not be used as a limitation of the present invention. The quantity of game terminals 200 is based on an actual requirement in a game application scenario. For example, at least two camps are allowed in a game session, and if each camp has four fixed game characters, at least eight game terminals 200 must be connected to this game session. The game terminal 200 can be a computer device such as a smart phone, a tablet computer, a notebook computer, or a desktop computer, and has a computing capability, input and output functions, and a network connection function. The server 100 may be a single server device, or may be a computer device capable of providing a game application service externally, such as a server cluster or a cloud server.

At present, a task line of the game session on the market is relatively single. A function of tapping the like icon and sending gifts by a spectating character to a spectated character can be implemented. However, a manner of interaction between the spectating character and the spectated character is still relatively limited, and an immersive game experience of a player corresponding to the spectating character and a player corresponding to the spectated character cannot be provided, and configuration of game links cannot be diversified. There is often an exclusion phenomenon in which a player who has been out of the game cannot obtain a game experience in the game session.

In view of the above problems, the present invention provides a game task processing method and a task processing system for a game session. The method and the system are described in detail below with reference to the accompanying drawings.

FIG. 2 is structural block diagram of a task processing system for a game session according to an embodiment of the present application.

As shown in FIG. 2, a task processing system 300 includes a server 100, a first game terminal 210, a second game terminal 220, and a game terminal 230 corresponding to a spectated character. A game terminal 200 in FIG. 1 is a collective term, and may be classified into a first game terminal 210, a second game terminal 220, and a game terminal 230 corresponding to the spectated character according to specific application scenarios. The classification method depends on a behavior state of a game character specifically corresponding to the game terminal 200 in a game session, rather than a hardware device. If a game character corresponding to a game terminal 200 has been killed in the current game session and has entered a state of spectating the game, the game terminal 200 is the first game terminal 210. Correspondingly, if a game character corresponding to a game terminal 200 is still in the game process and has not been killed in the game session, and is watched by another game terminal, the game terminal 200 corresponding to the spectated game character is the game terminal 230 corresponding to the spectated character. The game character is a virtual character controlled by the player to perform related operations in the game session, and can be a virtual character of a 3D model, and is controlled by the player to perform a movement or shooting operation. The spectating character, the spectated character, and the game character who is still in the game progress but is not watched are all belong to game characters. A quantity of first game terminals 210, a quantity of second game terminals 220, and a quantity of game terminals 230 corresponding to the spectated character may be one or more.

As an implementation, the server 100, the first game terminal 210, the second game terminal 220, and the game terminal 230 corresponding to the spectated character can communicate with each other to transmit and receive requests and data. The first game terminal 210 can send a game spectating request and request information including a predetermined task to the server 100. The second game terminal 220 is a game terminal that is other than the first game terminal 210 and that can send a game spectating request and a predetermined task update request to the server 100. The game terminal 230 corresponding to the spectated character sends game screen data to the server 100 and receives a predetermined task from the server 100.

As an implementation, the server 100 receives a game spectating request from the first game terminal 210, and sends a game screen of a spectated character corresponding to the game spectating request to the first game terminal 210, and the server 100 receives request information including at least one predetermined task from the first game terminal 210. The server 100 sends the predetermined task to at least one game terminal 200 in the game session. The server 100 responds to a determination operation received by any game terminal for the predetermined task, and determines that a game character who meets a predetermined condition is an executor of the predetermined task. The server 100 allocates a game resource reward to a game account corresponding to the executor based on an execution result of the predetermined task.

In one example, in a multiplayer joint game session, if a game character controlled by the user of the first game terminal 210 is killed in a current game session, the game character is out of the game and automatically becomes a spectating character. After clicking a game spectating request button on a game interface, the first game terminal 210 sends a game spectating request to the server 100. The game spectating request can be made for a specific spectated character, that is, a player corresponding to the spectating character can select a game character still in the game process in the game session as the spectated character. The server 100 transfers a game screen of the spectated game character corresponding to the game spectating request to the first game terminal 210, so that the effect of spectating the game is implemented. On the basis of having spectated the game, if the player corresponding to the spectating character wants to have a game interaction with the player corresponding to the spectated character, the player corresponding to the spectating character can submit request information including one or more predetermined tasks, and the request information is sent by the first game terminal 210 to the server 100. After receiving the request information, the server 100 releases the predetermined task to at least one game terminal 200, such as the game terminal 230 corresponding to the spectated character, or the second game terminal 220, or another game terminal corresponding to a game character who is still in the game process but has not been watched. Prompt information of the predetermined task is displayed on the game interface of the game terminal that receives the predetermined task, so that a user who sees the prompt information of the predetermined task can perform a determination operation on the predetermined task. When multiple predetermined tasks are released, prompt information of the multiple predetermined tasks can further be displayed on the game interface in a form of a task list. The server 100 releases the predetermined tasks, and can send the predetermined tasks to all game terminals in a broadcast mode. In other embodiments of the present application, the first game terminal 210 may send request information directed to a specific spectated character, and the server 100 only sends the request information to the game terminal 230 corresponding to the specific spectated character, to implement peer-to-peer task release. Alternatively, the first game terminal 210 sends a predetermined task to all members of a certain camp, to implement group-oriented task release. After a player corresponding to a certain game terminal performs a determination operation for the predetermined task, information about the determination operation is sent to the server 100, and the server 100 determines that a game character meeting a predetermined condition is an executor of the predetermined task. The predetermined condition may be a requirement for the level, camp, and equipment attribute of the game character. The predetermined condition can be configured by system default. For example, it must be a game character who is still in the game process and has not been out of the game that can accept the predetermined task, or a game character in the same camp as the spectating character can accept the predetermined task. The predetermined condition may be included in the request information, and is configured by the player corresponding to the first game terminal 210. After the executor is determined, the state of the predetermined task becomes in progress and cannot be claimed by another game character. After the executor completes the predetermined task, the server 100 performs settlement, and allocates a game resource reward to a game account corresponding to the executor.

In one example, the user of the first game terminal 210 may select to customize information about the predetermined task and the game resource reward, and the customized information about the predetermined task and the game resource reward are included in the request information. The user of the first game terminal 210 may select the information about the predetermined task and the game resource reward configured by system default, that is, the task released by the spectating character can be in a fixed package mode, that is, several task types and corresponding reward contents are configured in the game, and the player who wants to complete the predetermined task selects the corresponding task package.

The game character who meets the predetermined condition and determines claiming the predetermined task is determined by the server 100 as an executor of the predetermined task. When the executor successfully completes the predetermined task, the server 100 sends the reward content, that is, the game resource reward such as gold coins, experience points, and game equipment, corresponding to the predetermined task released by the first game terminal 210, to a game account of the executor.

In one example, the game resource reward corresponding to the task released by the spectating character may be selected by the user of the first game terminal 210 corresponding to the spectating character, and the user selects a customized predetermined task and the corresponding game resource reward. For example, the customized predetermined task is to kill a predetermined number of monsters or other game characters in the game, and the corresponding game resource reward is to obtain a predetermined number of gold coins. When the game server 100 receives the predetermined task released by the user of the first game terminal 210, the server 100 deducts the predetermined number of gold coins from a user account of the first game terminal 210 and temporarily stores the predetermined number of gold coins. After the executor claims the task and successfully completes the task, the server 100 allocates the predetermined number of gold coins to a user account corresponding to the executor.

In another example, the game resource reward may be provided by the system. The user of the first game terminal 210 selects a predetermined task in a fixed package mode. After the executor claims the predetermined task and successfully completes the predetermined task, the server 100 releases a predetermined reward according to the predetermined task in the fixed package mode. For example, the predetermined reward can be a gold coin reward, a game character experience point, and so on.

In one example, the server 100 determines, according to the content of the predetermined task, the minimum condition that needs to be met to complete the predetermined task. For example, the content of the task is to kill a monster, and the player needs to have 80 experience points and a special weapon at the same time. Therefore, in the current game session, a game character who has 80 or more experience points and has a special weapon can click on the task and claim the task. There is no limit to the number of game characters who can claim the task, provided that the game character meets the condition for claiming the task, and the game character who has less than 80 experience points or has no special weapon does not meet the requirement for claiming the task, and can only view the content of the task and the game resource reward.

As an implementation, both the first game terminal 210 and the second game terminal 220 can send an update request to the server 100 to upgrade the predetermined task, before the predetermined task is determined and claimed by any game character, or the predetermined task has been claimed by a game character but has not been completed, and the server 100 may update the predetermined task based on the update information.

As an implementation, the content of the predetermined task can be updated by using update information. The update information can include updating the predetermined task information and updating game resource reward information, that is, upgrading the predetermined task and the game reward. Specifically, the update information includes contents such as a difficulty level of the predetermined task, a quantity requirement for kills, limited completion time, and a changed game resource reward. The update information can be sent by the first game terminal 210 or the second game terminal 220, that is, the update of the predetermined task can be initiated by an original task releaser or by another player.

After the executor successfully completes the updated predetermined task, the server 100 sends the reward content corresponding to the updated predetermined task, that is, the game resource reward such as gold coins, experience points, and game equipment, to the game account of the executor.

In one example, a game character controlled by the user of the first game terminal 210 is a No. 1 spectating character, a game character controlled by the user of the second game terminal 220 is a No. 2 spectating character. The No. 1 spectating character releases a level-1 task, and the task content is to kill a monster with 50 experience points within three minutes, and reward the game character who completes the level-1 task with 100 gold coins, and the server 100 deducts 100 gold coins from a game account corresponding to the No. 1 spectating character. Before the level-1 task is claimed by the game character who meets the requirement for claiming the task, the No. 1 spectating character or the No. 2 spectating character believes that the task is relatively simple and wishes to upgrade the task, the level-1 task is upgraded to a level-2 task, and the content of the level-2 task is to kill two monsters with 100 experience points within three minutes. In order to keep the game character who has consulted the level-1 task interested in claiming the level-2 task, some extra game resource rewards are added while the difficulty of the level-1 task is updated. A corresponding game resource reward for the level-2 task is 200 gold coins. There is a reward difference of 100 gold coins between the level-1 task and the level-2 task. The server 100 deducts 100 gold coins or equivalent game resources from the game account corresponding to the No. 1 spectating character or the No. 2 spectating character who performs an operation of upgrading the level-2 task as the reward difference. The level-2 task is sent to all game terminals that are still in the game process in the game session. Finally, the game character who completes the level-2 task can get 200 gold coins.

In one example, any game terminal 200 may further send a refresh information request to the server 100 to refresh the list of predetermined tasks displayed on the game interface of the game terminal. In a game session, multiple predetermined tasks may be released at the same time, and therefore are displayed on the game terminal in the form of a task list. Some of the first game terminals 210 or the second game terminals 220 update the released predetermined tasks, or new predetermined tasks are released later, and a need to update the task list is created. The update information request is initiated by the game terminal, the player can trigger a refresh button on the game interface displayed on the game terminal, and after receiving the update information request, the server 100 responds to the requirement and sends the latest list of predetermined tasks to the above game terminal. In other embodiments of the present application, the server 100 may further periodically send the list of predetermined tasks to all game terminals to implement an automatic refresh function.

In one example, the predetermined task can be completed jointly by multiple game characters, and game resource rewards are allocated according to the contribution degree of each game character. For example, a predetermined task is to kill a game character A. A game character B and a game character C both accept the predetermined task and become executors, and during the game, both the game character B and the game character C perform shooting operations on the game character A, and finally kill the game character A. Health points of the game character A are 100 points, and the shooting operation of the game character B reduces the heath points of the game character A by 60 points, and the shooting operation of the game character C reduces the health points of the game character A by 40 points. If the game resource reward of the predetermined task is 100 gold coins, the game character B gets 60 gold coins, and the game character C gets 40 gold coins.

In one example, when a game character who meets the predetermined condition is determined to be an executor of the predetermined task, the system triggers a protection mechanism, that is, sets a state of the executor to a damage immunity state or a damage reduction state, and the above state can be maintained for a predetermined time. The predetermined time may be 5-10 seconds. Under this mechanism, when a game character accepts a predetermined task, the game character can have time to analyze the content of the predetermined task, make a plan, and ensure smooth completion of the predetermined task.

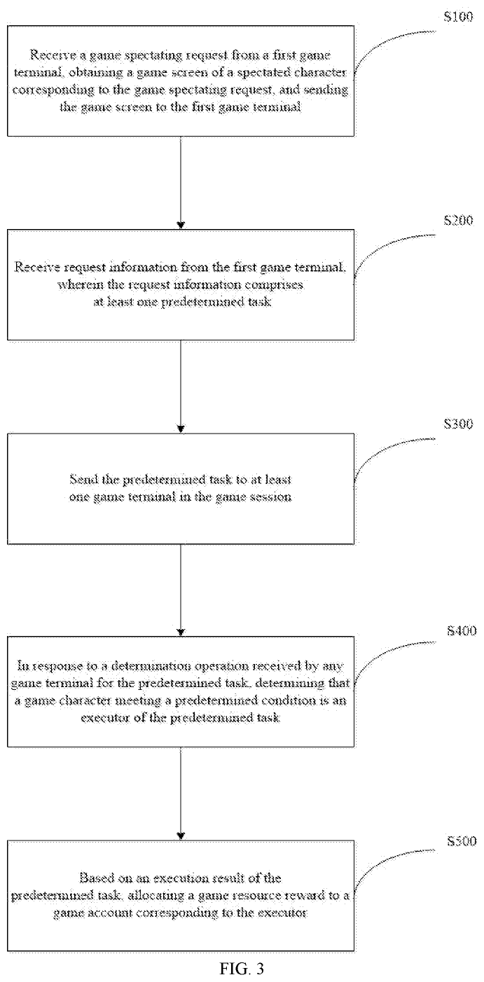

FIG. 3 is a flowchart of a task processing method for a game session according to an embodiment of the present invention.

As shown in FIG. 3, the cooperation of the server 100, the first game terminal 210, the second game terminal 220, and the game terminal 230 corresponding to the spectated character in FIG. 2 is required to implement a task processing method for a game session provided by an embodiment of the present invention. The method includes the following steps:

Step S100: Receive a game spectating request from the first game terminal 210, obtain a game screen of a spectated character corresponding to the game spectating request, and send the game screen to the first game terminal 210.

This step is an obtaining step. As an implementation, the game spectating request can be a game screen request from the perspective of any other game character who is still in the game progress in the current game session and that is independently selected by the player of the first game terminal 210, or can be a global screen request for the game session currently in progress. The game character corresponding to the first game terminal 210 and the spectated character belong to the same game session, and when the game character fails a task or is killed, the game character enters a spectator mode. In other embodiments of the present application, the game character controlled by the player can be optionally configured as a referee or spectator attribute, and watches the game throughout the game session. In this case, the player of the first game terminal 210 selects the referee or spectator attribute at the beginning of the game, and the first game terminal 210 sends a game spectating request to the server. The player of the first game terminal 210 may send a game spectating request to switch between different spectated characters during the game session. In the game session, there may be multiple spectating characters, and the multiple spectating characters can select to watch the same spectated character, or can respectively watch different spectated characters. The server 100 receives the game spectating request from the first game terminal 210, the server 100 obtains real-time game screen data from the game terminal 230 corresponding to the spectated character and sends the real-time game screen data to the first game terminal 210, and the first game terminal 210 obtains a displayed game screen, the game screen is consistent with the real-time game screen displayed on the game terminal 230 corresponding to the spectated character.

Step S200: Receive request information from the first game terminal, where the request information includes at least one predetermined task.

This step is a receiving step. The request information includes information that is about the predetermined task and the game resource reward, and both the predetermined task and the game resource reward are customized by the first game terminal 210. The predetermined task is key information for interaction between the spectating character of the game and the spectated character or another game character who is still in the game process. The user of the first game terminal 210 can select to customize the information about the predetermined task and the game resource reward, or select the information about the predetermined task and the game resource reward configured by system default, that is, the predetermined task released by the spectating character can be in a fixed package mode, that is, several predetermined task types and corresponding reward contents are configured in the game, and a potential game character who wants to complete the task selects the corresponding task package.

The game character controlled by the user of the first game terminal 210 is a spectating character who releases the task, and the player corresponding to the spectating character can see the predetermined task information and game resource reward information on a task selection interface of the game terminal. The predetermined task information is a collection of predetermined tasks that can be completed by different game characters that are still in the game process in the current session. The actual combat ability of the game characters may be strong or may be weak. In order to avoid ignoring and isolating a certain game character when releasing a predetermined task by the system, the server 100 collects the game session information of all the game characters that are still in the game process, formulates different types of predetermined tasks according to the information, and appropriately match these different types of predetermined tasks with game resource rewards. The player corresponding to the spectating character can see these matched predetermined tasks and game resource rewards on the task interface of the first game terminal 210. The player can arbitrarily select one or more matched predetermined tasks and game resource rewards, and then send the request information composed of the predetermined tasks and game resource rewards to the server 100. In the subsequent steps, the server 100 releases the matched predetermined tasks and game resource reward contents selected by the user of the first game terminal 210 to the corresponding task list displayed on the game interface displayed by the game terminals corresponding to other game characters.

In one example, the server 100 sets tasks of different difficulty levels based on the status of the experience points of the game characters in the current game session. The game characters in the primary experience stage are suitable for primary tasks, and the primary task content can be killing a primary monster to get a reward for upgrading primary equipment to intermediate equipment, or killing a small number of game characters in other camps or teams to get a reward of a small amount of gold coins. Game characters in the intermediate experience stage are suitable for intermediate tasks, and the intermediate task content can be killing one intermediate monster to get a reward for upgrading from primary equipment to advanced equipment, or killing a moderate number of game characters in other camps or teams to get a reward of a moderate amount of gold coins. Game characters in the advanced experience stage are suitable for advanced tasks, and the advanced task content can be killing one advanced monster to get a reward of the title of the ultimate player of the game, or killing a larger number of game characters in other camps or teams to get a reward of a larger amount of gold coins. The server 100 releases tasks of different difficulty levels to the task selection interface of the first game terminal 210, and the player corresponding to the spectating character can select one task or a combination of multiple tasks in the primary task, the intermediate task and the advanced task. After determining the selected task, the server deducts the corresponding game resources from the game account of the spectating character, and in a subsequent step, the content of the selected predetermined task and game resource reward is released to the task collection interface of the game terminal corresponding to another game character.

In another example, the spectating character can release the task content, and the spectating character can select to customize the content of the predetermined task and the content of the game resource reward on the task selection interface. For example, the spectating character hopes that the game character who accepts the predetermined task can kill a specific target, and can provide a game resource reward for the game character who completes the predetermined task. The predetermined task can be killing the ultimate monster king, or offering a reward for killing a specific game character, and the game resource reward is 100 game coins. When the spectating character selects the content of the predetermined task and the content of the game resource reward and sends the request information to the server 100, the server 100 determines whether there is a game character who meets the condition for claiming the task according to experience points, a force value and a health progress bar of all game characters still in the game progress in the current game session in the subsequent step. If the server 100 determines that there is a game character with comprehensive strength such as experience points, a force value, and a health progress bar that can complete the killing of the ultimate monster king, the server 100 releases the predetermined task customized by the spectating character to the game terminal corresponding to the game character. If the server 100 determines that there is no game character with comprehensive strength such as experience points, a force value, and a health progress bar that can complete the killing of the ultimate monster king, and the server 100 rejects the request information of the spectating character and prompts the first game terminal 210 to re-customize the task content.

A quantity of predetermined tasks may be one or more, and may be determined based on a quantity of tasks sent by the first game terminal 210 and determined by the server 100 as being executable.

In one example, the player of the first game terminal 210 selects multiple primary predetermined tasks and multiple advanced predetermined tasks, and the server 100 sends information about these primary predetermined tasks and advanced predetermined tasks to the game terminal corresponding to the game character still in the game progress. The user of the first game terminal 210 customizes a number of predetermined game tasks and sends the game tasks to the server 100. The server 100 determines and rejects the predetermined task that cannot be completed based on experience points, a force value, and a health bar progress of all game characters still in the game progress in the current game session, and continues to release the remaining predetermined tasks that can be completed to the game terminals corresponding to the game characters that meet the conditions.

The server 100 may further receive an information refresh request from any game terminal 200, and the refresh information request is used to refresh the list of predetermined tasks displayed on the game interface of any game terminal 200.

The game character controlled by the user of the first game terminal 210 is a spectating character, and the game character controlled by the user of the game terminal 230 is a spectated character. After obtaining a real-time game screen of the spectated character, the spectating character wishes to have game interaction with the spectated character in the current game session. The spectating character sends the request information whose content is to kill a specified monster and provide the killer with a game resource reward to the server 100 by using the first game terminal 210, and the server 100 sends the received request information to the game terminal 200 corresponding to the game character. The request information is continuously generated by the first game terminal 210 and is sent to the server 100, or multiple pieces of request information are sent to the server 100 by different first game terminals 210. Therefore, the predetermined tasks determined by the server 100 as being executable by the game characters that are still in the game process are also constantly newly added, and there is a need to refresh and display the predetermined task information. Any game terminal 200 sends a refresh information request to the server 100, and the server 100 sends the latest predetermined task list to the game terminal 200, the game interface of the game terminal 200 displays the content of the latest optional predetermined tasks and game resource rewards, and the server 100 can further update the task list of the game terminal 230 corresponding to the spectated character to display the content of the latest executable predetermined task information and game resource reward information.

In one example, the spectating character releases a predetermined task with the content that a primary armor can be obtained by killing a primary spirit monster. The game character who is still in the game progress sees the predetermined task content on the task interface of the game. Three minutes later, the spectating character newly adds and releases a predetermined task with the content that the ultimate beast king is killed to obtain the title of the ultimate player. A player corresponding to a certain game character is not interested in the content of the above predetermined task and hopes to find a more suitable task. Then, the player clicks a task refresh button on the task interface, and the player can see the content of the newly added predetermined task. Finally, after several refreshes, the player finds a predetermined task, the content of which is to find a teammate and kill an intermediate monster. and the corresponding game resource reward is to get a gas mask. After the player determines the predetermined task and successfully completes the task, the server refreshes the task list and deletes the completed predetermined task in the task list. The server 100 broadcasts the task list every once in a while, so that the game terminal that is still in the game process displays the latest predetermined tasks and game resource rewards.

The request information received by the server 100 further includes deducting game resource reward from the game account corresponding to the first game terminal 210 and temporarily storing the game resource reward.

As an implementation, the first game terminal 210 sends request information to the server 100. The request information includes the predetermined task and the corresponding game resource reward. When the server 100 determines that the predetermined task can be executed, the game resource reward of the game account corresponding to the first game terminal 210 is deducted by the server 100 and temporarily stored in the database of the server 100.

In one example, the spectating character of the first game terminal 210 wishes to have game interaction with the game terminal 230 corresponding to the spectated character, and the player corresponding to the spectating character selects the matched predetermined task and game resource reward on the task selection interface of the game terminal 210, the first game terminal 210 sends request information to the server 100, the predetermined task content in the request information is that a primary armor can be obtained by killing a primary spirit monster, and the server 100 receives the request information from the first game terminal, and sends determination information for deducting a primary armor to the first game terminal 210. If there is a primary armor in the game account of the spectating character, when the spectating character clicks the determination information, the server 100 deducts a primary armor from the game account corresponding to the spectating character. If there is no primary armor in the game account of the spectating character, when the spectating character clicks the determination information, the server 100 fails to find a primary armor in the game account corresponding to the spectating character, the server 100 sends purchase determination information to the first game terminal 210. After the spectating character determines the purchase of a primary armor and successfully makes a payment, the server 100 deducts the gold coins in the game account corresponding to the spectating character, or the server 100 receives remittance through a remittance channel from the prior art, and provides a primary armor for the spectating character, and the server 100 temporarily stores the game resource reward information whose content is a primary armor in the internal database. In the subsequent steps, after any game character claims the predetermined task and successfully kills a primary monster, the server 100 determines that a result of completing the task by the game character is valid, and sends a primary armor to the game account corresponding to the game character, and the game character can view the primary armor in the game account.

In another embodiment, the game resource reward is generated and settled by the game system. When any game character claims and completes the predetermined task, the system generates a corresponding game resource reward and allocates the game resource reward to the game account of the game character, and the number of game resources does not change in the game account of the spectating character who releases the predetermined task.

Step S300: Send the predetermined task to at least one game terminal corresponding to the spectated character in the game session.

This step is a sending step. The server 100 sends relevant information of the predetermined task obtained from the first game terminal 210 to at least one game terminal 200 in the game session. The game terminal can be the game terminal 230 corresponding to the spectated character, or can be another game terminal that is still in the game process but is not spectated in this game session, or can be the first game terminal 210 and the second game terminal 220.

In one example, the server 100 receives a predetermined task whose content is entering the finals to shoot an intermediate player within three minutes, and the corresponding game resource reward is advanced shooting equipment, the server 100 can send the content of the predetermined task and the game resource reward to the game terminal 200 corresponding to all the game characters in the game process in the current game session. Alternatively, the server 100 can select to only send the content to the game terminal corresponding to the game character with game experience points, a force value and a health bar progress value that can complete the killing task, or the server 100 can send the content to any at least one game terminal 230 corresponding to the spectated character, or the server 100 can only send the predetermined task information to the game terminal 230 corresponding to the spectated character specified by the spectating character who releases the predetermined task. While the server 100 sends the predetermined task information to the game terminal, the spectating character who releases the predetermined task can check the release status and claiming status of the predetermined task on the game interface for game spectating. The spectating character of the remaining second game terminal 220 can also see the releasing status and claiming status of the predetermined task.

Step S400: Responding to a determination operation received by any game terminal for the predetermined task, determine that the game character meeting the predetermined condition is an executor of the predetermined task.

This step is a determination step. Information about the predetermined task is displayed on all game terminals that receive the predetermined task. Correspondingly, players of the above game terminals can select whether to accept the predetermined task, and if the players want to accept the predetermined task, the players can perform a determination operation for the predetermined task on the game interface. The determination operation may be a touch or click operation on a determination button. The server 100 needs to determine whether the game character corresponding to the determination operation meets the predetermined condition, and when the game character meets the predetermined condition, it is determined that the game character is an executor of the predetermined task. The predetermined condition may be an experience level, an equipment level, a camp, etc. of the game character. For example, there are game characters of four camps of ABCD in a game session. When a spectating character of camp A releases a predetermined task, and a predetermined condition of the predetermined task is that only a game character of the same camp can become an executor, the server 100 determines whether the game character corresponding to the game terminal performing the determination operation belongs to camp A, and if yes, the game character is determined as an executor of the predetermined task. If multiple game terminals that meet the predetermined condition send determination operations within a period of time, the server determines a game character of a game terminal that first sends the determination operation as an executor according to the order in which the determination operations are received. If the spectating character has designated a specific spectated character as a task recipient when releasing the predetermined task, the server only needs to determine whether the specific spectated character has returned the determination operation.

As an implementation, within a predetermined time after the server 100 determines that any game character is an executor of the predetermined task, the server 100 sets a state of the executor to a damage immunity state or a damage reduction state. That is, the game character determined as an executor is protected by the system within the predetermined time, so that the player has sufficient time to browse the content of the predetermined task and formulate an action plan. The predetermined time may be 5-10 seconds.

It is worth noting that any game character may be one spectated character, or may be multiple spectated characters, or may be a game character who has not been spectated but is still in the game process, and the quantity of spectated characters should not be used as a limitation to the present invention.

There is an interactive ranking list for the spectating characters and the spectated characters on a display interface of the game terminal 200. All the spectated characters in the current game session are ranked according to the degree of interaction activity, such as the number of gifts obtained, the number of kills, and the number of spectated game characters. The interactive ranking list is refreshed every once in a while, and the top ranked players are displayed in a highlighting manner. The display interface includes a video replay function, which automatically generates a video replay of completing the task by the spectated character. In this way, it is convenient for the spectating character and the spectated character to replay the screen of the task completion, and the video replay can be generated in a game perspective of the spectated character.

Step S500: Based on an execution result of the predetermined task, allocate a game resource reward to a game account corresponding to the executor.

This step is a settlement step. As an implementation, the server 100 determines whether the predetermined task is executed successfully, such as, determines whether the number of monsters killed by the executor meets the number of monsters to be killed specified in the predetermined task, or whether the executor kills a game character to be killed specified in the predetermined task. If the task is successfully executed, the server 100 performs a settlement of the game resource reward, and allocates the game resource reward corresponding to the predetermined task to the game account of the executor. Further, when there are multiple executors for a predetermined task, the server 100 determines the degree of contribution of each executor to the completion of the predetermined task, and allocates the game resource reward based on the degree of contribution, and the server 100 temporarily adds the game resource reward corresponding to the predetermined task temporarily stored internally into the game account corresponding to the executor.

In one example, the server 100 receives a predetermined task whose content is entering the finals to shoot a high-level game character within three minutes, and a corresponding game resource reward is 500 gold coins, and the server 100 releases the predetermined task and game resource reward information to multiple game terminals. Before the predetermined task is completed, determination operations are adopted for a No. 1 spectated character, a No. 2 spectated character, a No. 3 spectated character, a No. 4 spectated character, and a No. 5 spectated character to claim the predetermined task. A game experience value of the No. 1 spectated character is a primary experience value, the No. 1 spectated character is not qualified to kill an advanced game character, and a force value of the No. 2 spectated character is too low, and the No. 2 spectated character is not qualified to kill an advanced game character. The server 100 automatically determines that the No. 1 spectated character and the No. 2 spectated character do not meet the predetermined condition for claiming the predetermined task and sends a reminder to the game terminals corresponding to the No. 1 spectated character and the No. 2 spectated character. The predetermined task is finally claimed by the No. 3 spectated character, the No. 4 spectated character, and the No. 5 spectated character who meet the predetermined condition. In the game duel, the No. 3 spectated character is unfortunately eliminated. In the end, the No. 4 spectated character and the No. 5 spectated character shoot at the advanced game character as the target at the same time, and finally the target is successfully killed. The No. 4 spectated character contributes two-fifths of the damage value in the battle, and the No. 5 spectated character contributes three-fifths of the damage value in the battle. Finally, the server 100 adds 200 gold coins to a game account of the No. 4 spectated character and 300 gold coins into a game account of the No. 5 spectated character according to the degree of contribution of the No. 4 spectated character and the No. 5 spectated character in completing the predetermined tasks.

In one example, the server 100 receives a predetermined task of entering the finals to shoot an intermediate game character within three minutes, and a corresponding game resource reward is 300 gold coins. The server 100 releases the content of the predetermined task and the game resource reward to the game terminal 230 corresponding to multiple spectated characters. The No. 1 spectated character, the No. 2 spectated character, and the No. 3 spectated character simultaneously determine and claim the task. A game experience value of the No. 1 spectated character is a primary experience value and does not meet the qualification for killing an intermediate player. The server 100 automatically determines that the No. 1 spectated character does not meet the condition for claiming the predetermined task and sends a reminder to the game terminal corresponding to the No. 1 spectated character, and the predetermined task is eventually claimed by the No. 2 spectated character and No. 3 spectated character who meet the condition for claiming the task. In the game duel, the No. 2 spectated character and the No. 3 spectated character simultaneously shoot at the intermediate game character as the target. In the end, the intermediate target character is successfully killed. The No. 2 spectated character contributes one-third of the damage value in the battle, and the No. 3 spectated character contributes two-thirds of the damage value in the battle. Finally, in the subsequent settlement step, the server 100 adds 100 gold coins and 200 gold coins to the game accounts of the No. 2 spectated character and the No. 3 spectated character respectively based on the degree of contribution of the No. 2 spectated character and the No. 3 spectated character in completing the predetermined task.

The method further includes a step of updating the predetermined task. The server 100 receives update information for updating the predetermined task from the first game terminal 210 or the second game terminal 220, provided that the predetermined task is not determined and claimed by any game character, the server 100 can update the predetermined task based on the update information. Alternatively, after the predetermined task is determined and claimed by any game character, before the predetermined task is completed, the server 100 may update the predetermined task based on the update information. The update information includes any one or a combination of two or more among a difficulty level of the predetermined task, a quantity requirement for kills, limited completion time, and the game resource reward. The server 100 sends the updated predetermined task to at least one game terminal in the game session.

In one example, in a multiplayer joint game session scenario, the game character controlled by the user of the first game terminal 210 is a spectating character, and the user of the game terminal 230 corresponding to the spectated character is a spectated character. The spectating character of the first game terminal 210 selects the predetermined task information and game resource reward information whose content is to kill two monsters to get ten gold coins. The server 100 releases the predetermined task information and the game resource reward information to the task list and broadcasts the task list to each game terminal. During the process of claiming and executing the predetermined task by any game character, the spectating character of the first game terminal 210 upgrades the predetermined task and game resource reward. The original content is upgraded to that 20 gold coins can be gotten by killing four monsters, and the server 100 releases the upgraded task information and game resource reward information to the task list of the game character who is executing the predetermined task.

In another example, in a multiplayer joint game session scenario, the second game terminal 220 is a game terminal that is other than the first game terminal 210 and that can send a game spectating request and a predetermined task update request to the server 100, and a player of the second game terminal 220 is a spectating character, and a player of the game terminal 230 corresponding to the spectated character is a spectated character. The player of the second game terminal 220 selects the task information and the game resource reward information whose content is that ten gold coins can be gotten by killing two monsters. The server 100 releases the task information and the game resource reward information to the task list. During the process of claiming and executing a task by any game character, the player of the second game terminal 220 upgrades the task and the game resource reward, and upgrades the original content to that twenty gold coins can be obtained by killing four monsters. The server 100 releases the upgraded task information and game resource reward information to the task list of the game character who is executing the predetermined task.

In one example, a predetermined task whose content is that ten gold coins can be obtained by killing two monsters is determined and claimed by the No. 1 spectated character. During the process in which the No. 1 spectated character executes the predetermined task, the player of the second game terminal 220 upgrades the predetermined task and the game resource reward, and the server 100 limits the scope of the upgrade content, so that the task content is within the ability limit in which the player corresponding to the No. 1 spectated character is able to complete. The predetermined task is finally upgraded to that 20 gold coins are gotten by killing four monsters. The player corresponding to the No. 1 spectated character can select to continue to execute the updated task. After the task of killing four monsters is successfully completed, the server 100 sends 20 gold coins to the game account corresponding to the No. 1 spectated character.

Upgrading the task can help reduce the burden on players to complete the task, reduce the number of tasks to be claimed, improve the task reward, and provide a better game experience.

As an implementation, the server 100 further sends at least one among the first display information, the second display information, and the third display information to at least one game terminal 200. The second display information is sent at predetermined time intervals. The first display information includes at least one among the task list, task progress, an operation button, and a status prompt, that is, the content of the first display information is sent to the game terminal 200 in a regularly refreshed manner, so that the game terminal 200 refreshes the display content, and the predetermined time interval can be 1-10 seconds. The second display information includes at least one among a game resource reward, a predetermined task, and a list of spectating users. The third display information includes at least one among adding friends, video replay, and switching spectated characters.

In one example, the user of the game terminal 200 can check the first display information on the game interface, the user of the first game terminal 210 can see the matched predetermined task and game resource reward, after clicking an operation button to select a predetermined task and determining to release the task, the claiming status and execution progress status of the predetermined task can be seen in the task list.

In one example, the user of the game terminal 200 can view the second display information on the game interface, and the user of the game terminal 230 corresponding to the spectated character whose game name is “Reganmian” in the spectating list of the game interface sees basic information such as a game avatar and a game name of a player who is watching the game, and the spectated character can see that a spectating character named “Bingtanghulu” releases a predetermined task and a game reward that two spirit monsters are killed and ten gold coins are provided.

In one example, the user of the game terminal 200 can view the third display information on the game interface, after a spectated character “Reganmian” successfully completes a predetermined task that is released by a spectating character whose game name is “bingtanghulu” and whose content is to kill two monsters and provide 10 gold coins, the spectated character can select to add “bingtanghulu” as a friend to further express gratitude, and the process of completing the predetermined task is very wonderful. Both the spectated character “Reganmian” and the spectating character “bingtanghulu” can select to rewatch the replay of the game process in a video replay interface. If the spectating character “Bingtanghulu” finds that the game session is not wonderful while watching the spectated character “Reganmian”, the spectating character can select a character button for switching the spectated character, to watch a real-time game screen of another game character in game session.

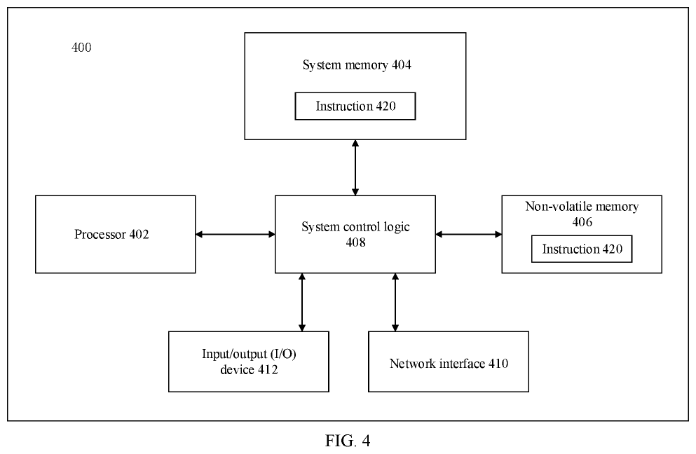

FIG. 4 is a structural block diagram of hardware of an electronic device according to an embodiment of the present application.

As shown in FIG. 4, an electronic device 400 may include one or more processors 402, a system board 408 connected to at least one of the processors 402, a system memory 404 connected to the system board 408, a nonvolatile memory (NVM) 406 connected to the system board 408, and a network interface 410 connected to the system board 408.

The processor 402 may include one or more single-core or multi-core processors. The processor 402 may include any combination of a general-purpose processor and a special-purpose processor (such as, a graphics processing unit, an application processor, or a baseband processor). In an embodiment of the present invention, the processor 402 may be configured to perform the task processing method shown in FIG. 3.

In some embodiments, the system board 408 may include any suitable interface controller, to provide any suitable interface for at least one of the processors 402 and/or any suitable device or component communicating with the system board 408.

In some embodiments, the system board 408 may include one or more memory controllers to provide an interface connected to the system memory 404. The system memory 404 may be used to load and store data and/or an instruction. In some embodiments, the system memory 404 of the electronic device 400 may include any suitable volatile memory, such as a suitable dynamic random access memory (DRAM).

The nonvolatile memory 406 may include one or more tangible and non-transitory computer-readable storage medium for storing data and/or the instruction. In some embodiments, the nonvolatile memory 406 may include any suitable nonvolatile memory such as a flash memory and/or any suitable nonvolatile storage device, such as a HDD (Hard Disk Drive, hard disk drive), a CD (Compact Disc, Compact Disc) drive, a DVD (Digital Versatile Disc, Digital Versatile Disc) drive.

The nonvolatile memory 406 may include a portion of storage resources installed on the apparatus of the electronic device 400, or may be accessed by a device, but is not necessarily part of a device. For example, the nonvolatile memory 406 may be accessed over a network via the network interface 410.

In particular, the system memory 404 and the nonvolatile storage 406 may respectively include: a temporary copy and a permanent copy of the instruction 420. The instruction 420 may include: an instruction that causes the electronic device 400 to implement the task processing method shown in FIG. 3 when executed by at least one of the processors 402. In some embodiments, the instruction 420, hardware, firmware, and/or software components thereof may additionally/alternatively reside in the system board 408, the network interface 410, and/or the processor 402.

The network interface 410 may include a transceiver for providing a radio interface for the electronic device 400 to communicate with any other suitable devices (such as, a front-end module and an antenna) by using one or more networks. In some embodiments, the network interface 410 may be integrated with other components of the electronic device 400. For example, the network interface 410 may be integrated into at least one of the processor 402, the system memory 404, the NVM 406, and a firmware device (not shown) having an instruction, and when at least one of the processors 402 executes the instruction, the electronic device 400 implements one or more among the various embodiments shown in FIG. 3.

The network interface 410 may further include any suitable hardware and/or firmware to provide a multiple-input multiple-output wireless interface. For example, the network interface 410 may be a network adapter, a wireless network adapter, a telephone modem, and/or a wireless modem.

In one embodiment, at least one of the processors 402 may be packaged with one or more controllers used for the system board 408 to form a system in a package (SiP). In one embodiment, at least one of the processors 402 may be integrated on the same die with one or more controllers used for the system board 408 to form a system on a chip (SoC).

The electronic device 400 may further include: an input/output (I/O) device 412 connected to the system board 408. The I/O device 412 may include a user interface, so that a user can interact with the electronic device 400; peripheral components can also interact with the electronic device 400 by using a design of a peripheral component interface. In some embodiments, the electronic device 400 further includes a sensor for determining at least one of environmental conditions and location information related to the electronic device 400.

In some embodiments, the I/O device 412 may include, but is not limited to, a display (such as, a liquid crystal display and a touch screen display), a speaker, a microphone, one or more cameras (such as, a still image camera and/or a video camera), a flashlight (such as, a LED flash), and a keyboard.

In some embodiments, the peripheral component interface may include, but is not limited to, a nonvolatile memory port, an audio jack, and a power interface.

It can be understood that, the structure illustrated in the embodiment of the present invention does not constitute a specific limitation on the electronic device 400. In other embodiments of the present application, the electronic device 400 may include more or fewer components than those shown in the figure, or combine some components, or split some components, or have different component arrangements. The illustrated components may be implemented in hardware, software, or a combination of software and hardware.

Program code can be applied to input instructions to perform the functions described in the present invention and to generate output information. The output information may be applied to one or more output devices in a known manner. For purposes of the present application, a system used for processing the instructions and including the processor 402 includes any system with a processor such as a digital signal processor (DSP), a microcontroller, an application specific integrated circuit (ASIC), or a microprocessor.

The program code can be implemented in a high-level programming language or an object-oriented programming language to communicate with a processing system. The program code can also be implemented in an assembly language or a machine language, if desired. In fact, the mechanism described in the present invention is not limited in scope to any particular programming language. In either case, the language may be an assembly language or an interpreted language.

According to an embodiment of the present invention, a non-transitory computer-readable storage medium is further provided, at least one computer instruction is stored in the non-transitory computer-readable storage medium, and the at least one instruction is loaded and executed by a processor, so as to implement the task processing method.

According to an embodiment of the present invention, a computer program product is further proposed, the computer program product includes a computer instruction, and when the computer instruction is executed, the task processing method is implemented.

Illustrative embodiments of the present invention include, but are not limited to, a task processing method and system for a game session, a device, a medium, and a program product.

Various aspects of the illustrative embodiments are described by using terms commonly used by persons skilled in the art to convey the substance of their work to others skilled in the art. However, it is apparent to the persons skilled in the art that some alternative embodiments may be practiced by using some of the described features. For purposes of explanation, specific numbers and configurations are set forth in order to provide a more thorough understanding of the illustrative embodiments. However, it is apparent to the persons skilled in the art that alternative embodiments may be practiced without the specific details. In other instances, well-known features have been omitted or simplified herein in order to avoid obscuring the illustrative embodiments of the invention.

Additionally, various operations are described as multiple discrete operations in a manner that is most helpful in understanding the illustrative embodiments. However, the order of description should not be construed as to imply that these operations are necessarily dependent on the order of description, many of which operations may be performed in parallel, concurrently, or simultaneously. In addition, the order of operations can also be rearranged. When the described operations are completed, the processing may be terminated, but may further have additional steps not included in the figures. The processing may be corresponding to a method, a function, a procedure, a subroutine, a subprogram, or the like.

References in the specification to “an example”, “in an example”, “an embodiment”, “an implementation” and the like indicate that the described embodiments may include specific features, structures or properties, but each embodiment may or may not necessarily include specific features, structures or properties. Moreover, these phrases do not necessarily refer to the same embodiment. Furthermore, when certain features are described with reference to specific embodiments, the knowledge of the persons skilled in the art can affect the combination of these features with other embodiments, whether or not those embodiments are explicitly described.

Unless the context otherwise requires, the terms “comprising,” “having,” and “including” are synonyms. The phrase “A and/or B” indicates “(A), (B) or (A and B)”.

As used herein, the term “module” may refer to, be a part of, or include: a memory (shared, dedicated, or group), an application-specific integrated circuit (ASIC), an electronic circuit, and/or a processor (shared, dedicated, or a group) that can execute one or more software or firmware programs, a combinatorial logic circuit, and/or another proper component that provides the function.

In the drawings, some structural or methodological features may be shown in a particular arrangement and/or order. However, it should be understood that no such specific arrangement and/or ordering is required. Rather, in some embodiments, features may be described in a different manner and/or order than shown in the illustrative figures. In addition, the inclusion of structural or methodological features in a particular figure does not imply that all embodiments need to include such features, and in some embodiments, these features may not be included or may be combined with other features.

In the description provided herein, numerous specific details are set forth. However, it is understood that embodiments of the invention may be practiced without these specific details. In some instances, well-known methods, structures and techniques have not been shown in detail in order not to obscure the understanding of this description.

Similarly, it should be understood that in the above description of exemplary embodiments of the present invention, in order to streamline the present invention and to facilitate an understanding of one or more of the various inventive aspects, various features of the present invention are sometimes grouped together in a single embodiment, figure, or in its description. However, the method of this disclosure is not to be interpreted as reflecting an intention that the protected present invention requires more features than the features that are expressly recorded in each claim. Rather, as the claims reflect, inventive aspects lie in less than all features of a single foregoing disclosed embodiment. Therefore, the claims following a specific implementation are hereby expressly incorporated into this specific implementation, and each claim serves as a separate embodiment of the present invention.

The person skilled in the art can understand that the modules in the device in the embodiment can be adaptively changed and arranged in one or more devices different from the embodiment. Modules or units or components in the embodiments may be combined into one module or unit or component, and furthermore may be divided into a plurality of sub-modules or sub-units or sub-components. Except a fact that at least some of these features and/or processes or units are mutually exclusive, all disclosed features and all processes or units of any method or device that are disclosed in such a way in this specification (including the appended claims, the abstract, and the accompanying drawings) may be combined in any combination mode. Unless otherwise explicitly stated, each feature disclosed in this specification (including the appended claims, the abstract, and the accompanying drawings) may be replaced by an alternative feature that serves same, equivalent, or similar purposes.

Furthermore, the person skilled in the art can understand that although some embodiments described herein include some features included in other embodiments but not others, combinations of features from different embodiments are meant to be within the scope of the present invention and form different embodiments. For example, in the claims, any one of the protected embodiments can be used in any combination.

1. A task processing method for a game session, comprising:
an obtaining step, receiving a game spectating request from a first game terminal, obtaining a game screen of a spectated character corresponding to the game spectating request, and sending the game screen to the first game terminal;
a receiving step, receiving request information from the first game terminal, wherein the request information comprises at least one predetermined task;
a sending step, sending the predetermined task to at least one game terminal in the game session;
a determination step, in response to a determination operation received by any game terminal for the predetermined task, determining that a game character meeting a predetermined condition is an executor of the predetermined task; and
a settlement step, allocating a game resource reward to a game account corresponding to the executor based on an execution result of the predetermined task.

2. The task processing method according to claim 1, wherein the task processing method comprises:
an updating step, receiving update information from the first game terminal or a second game terminal, wherein the update information is used to update the predetermined task; wherein
the sending step comprises sending the updated predetermined task to at least one game terminal in the game session.

3. The task processing method according to claim 2, wherein the update information comprises:
any one or a combination of two or more among a difficulty level of the predetermined task, a quantity requirement for kills, limited completion time, and the game resource reward.

4. The task processing method according to claim 1, wherein,
the receiving step further comprises: deducting the game resource reward from a game account corresponding to the first game terminal and temporarily storing the game resource reward; and
the settlement step comprises, based on the execution result of the predetermined task, adding the game resource reward into a game account corresponding to the executor.

5. The task processing method according to claim 1, wherein the game resource reward is generated and settled by a game system.

6. The task processing method according to claim 1, wherein the request information comprises information that is about the predetermined task and the game resource reward, and both the predetermined task and the game resource reward are customized by the first game terminal.

7. The task processing method according to claim 1, wherein the receiving step further comprises:
receiving a refresh information request from any game terminal, wherein the refresh information request is used to refresh a list of predetermined tasks displayed on a game interface of any game terminal.

8. The task processing method according to claim 1, wherein the settlement step comprises:
determining a degree of contribution of the executor to completion of the predetermined task, and distributing the game resource reward based on the degree of contribution.

9. The task processing method according to claim 1, wherein, in the determination step, within a predetermined time after determining that a game character meeting the predetermined condition is an executor of the predetermined task, a state of the executor is set to be a damage immunity state or a damage reduction state.

10. The task processing method according to claim 1, wherein the sending step comprises: sending, to the at least one game terminal, at least one among first display information, second display information, and third display information, wherein the second display information is sent at predetermined time intervals;
the first display information comprises at least one among a task list, a task progress, an operation button, and a state prompt;
the second display information comprises at least one among the game resource reward, the predetermined task, and a list of spectating users; and
the third display information comprises at least one among adding a friend, replaying a video, and switching the spectated character.

11. An electronic device, wherein the device comprises a processor and a memory storing a computer-executable instruction, and the processor is configured to execute the instruction to implement the task processing method according to any one of claims 1-10.

12. A computer-readable storage medium, wherein at least one computer instruction is stored in the computer-readable storage medium, and the at least one instruction is loaded and executed by a processor, to implement the task processing method according to any one of claims 1-10.

13. A computer program product, wherein the computer program product comprises a computer instruction, and when the computer instruction is executed, the task processing method according to any one of claims 1-10 is implemented.

14. A task processing system for a game session, comprising a server and at least one game terminal, wherein:
the server receives a game spectating request from a first game terminal, obtains a game screen of a spectated character corresponding to the game spectating request, and sends the game screen to the first game terminal;
the server receives request information from the first game terminal, wherein the request information comprises at least one predetermined task; and the server sends the predetermined task to at least one game terminal in the game session;
in response to a determination operation received by any game terminal for the predetermined task, the server determines that a game character who meets a predetermined condition is an executor of the predetermined task; and
the server allocates a game resource reward to a game account corresponding to the executor based on an execution result of the predetermined task.
